(19) United States
(12) Patent Application Publication
(10) Pub. No.: US 2005/0084318 A1
(43) Pub. Date: Apr. 21, 2005

(54) Upwardly-joined fluids applicators and receptacles therefor

(76) Inventor: Todd A. Bland, Omaha, NE (US)

Correspondence Address: Todd A. Bland, 13708 Frederick Avenue, Omaha, NE, 68138, US

(21) Appl. No.: 10/688,736

(22) Filed: Oct. 20, 2003

(51) Int. Cl. B05C 1/00; A46B 11/00

(52) U.S. Cl. 401/17; 401/118; 401/122

(57) ABSTRACT

Two, or more parallel vertical shafts extend downwardly from a horizontal connecting bridge and which bridge is provided with an upwardly extending, manually wieldable handle. Shafts' lower portions are provided with selectable applicators for selectable surface applyable fluids, and which applicators are preferably fluids-augmentable taking brush-like and/or dauber-like configurations, and conceivably alternatively taking semi-solid configurations such as for lipsticks and other semi-solid cosmetics. The parallel shafts, including their selectable applicators, can be downwardly securely, but readily removably upwardly retrievably, inserted through roof-apertures of an uprightable receptacle, and which receptacle might be internally charged with one or more fluid-augmentations for brush-like and/or dauber-like fluids applicators.

### BACKGROUND OF THE INVENTION

Well known are prior art devices directed to the tasks of applying fluids to a receptive surface (such as paints to utilitarian and/or artistic surfaces, as cosmetics to anatomical surfaces, etc.) are various prior art Fluids Applicators consisting of a single vertical-wise shaft downwardly provided with a selectable brush-like element. However, such prior art devices do not address the heretofore unsatisfied recognition for rapidly substantially simultaneously applying a single fluid to adjacently separated receptive surfaces, nor to substantially simultaneously applying visually and/or chemically differing fluids to one or more receptive surfaces.

### GENERAL OBJECTIVES OF THE INVENTION

In view of the foregoing, it is accordingly among the General Objectives of the present invention to address inattention of prior art workers to the problems of rapidly, substantially applying one or more single and/or disparate fluids to adjacently separated receptive surfaces.

### GENERAL STATEMENT OF THE INVENTION

With the aforementioned General Objectives in view, and together with other related and ancillary objectives, which will become more apparent as the ensuing Detailed Description of the Drawing proceeds, the “Upwardly-Joined Fluids Applicators (and possible Receptacles therefor)” of the present invention generally comprises:
(A) a plurality of substantially parallel and directionally longitudinal and directionally transversely separated vertical shafts, and each of which vertical shafts has a lower-end and thereat equipped with variously selectable fluid applicator elements. The selectable fluids applicator elements are preferably fluids-augmentable (such as brush-like and/or dauber-like configurations), or alternatively as semi-solid cosmetic configurations;
(B) located loftily above the lower-end and the there proximate fluid applicator element of the said parallel vertical shafts, a directionally transversely extending and substantially horizontal bridge member connected to upper portions of the respective vertical shafts;
(C) extending upwardly from the bridge member, a manually wieldable handle means; and desireably also
(D) a said sub-generically “Upwardly-Joined Fluids Applicator” being removably securely downwardly insertable through applicators' receiveable roof-apertures of an uprightable receptacle chargeable therewithin of a single applyable fluid and/or a plurality of segregated and visually distinct applyable fluids.

### BRIEF DESCRIPTION OF THE DRAWING

In the drawing, wherein like characters refer to like parts in the several views, and in which:

FIG. 1 is a vertically extending side elevational view of a representative embodiment (10A) of the “upwardly-joined fluids-applicators” of the present invention;

FIG. 2 is a vertically extending side elevational view of a second embodiment (10B) of the “upwardly-joined fluids-applicators” of the present invention;

FIG. 3 is a vertically extending side elevational view of embodiments 10A and 10B taken along lines 3-3 of FIGS. 1 and 2;

FIG. 4 is an upwardly extending plan view taken along the horizontally extending section lines 4-4 of FIGS. 1, 2 and 3;

FIG. 5 is a topical and downwardly extending plan view of a representative receptacles (50A, 50B) for the “upwardly-joined fluids-applicators (e.g. 10A, 10B) of the present invention;

FIG. 6 is a sectional elevational view wherein the FIG. 3 elevational view for embodiments 10A and 10B is mountably housed within a receptacle embodiment 50A;

FIG. 7 is a sectional elevational view wherein the FIG. 3 elevational view for embodiments 10A and 10B is mountably housed within a receptacle embodiment 10B; and wherein for FIGS. 6 and 7, phantom lines indicate the temporary upward withdrawal from receptacles (e.g. 50A, 50B) of an “upwardly-joined fluids-applicator” (e.g. 10A, 10B) of the present invention.

DETAILED DESCRIPTION OF THE DRAWING

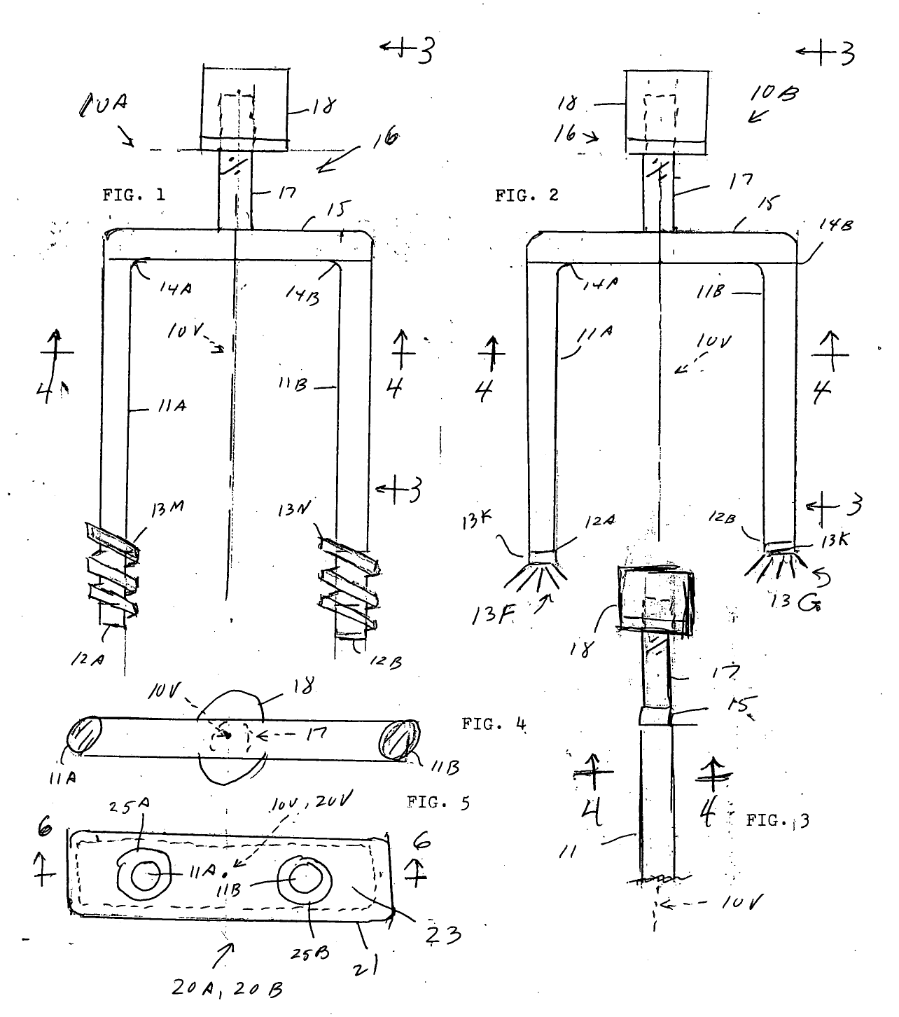

Reference character 10 refers to the general concept of the “Upwardly-Joined Fluids Applicator” of the present invention and more specifically alluded to in Drawing FIGS. 1-4 as representative embodiments 10A and 10B. Such representative embodiments 10A and 10B utilize, for the fluids applicator elements, those of the fluids-augmentable types, such as taking the configurations of brush-like forms and/or dauber-like forms.

In the representative embodiment 10A-depicted in Drawing FIGS. 1, 3, and 4: a pair of directionally longitudinal vertical shafts 11A and 11B directionally transversely horizontally flank a vertical-axis 10V therebetween, the vertical shaft 11A having a lower-end 12A and an upper-end 14A, and the vertical shaft 11B having a lower-end 12B and an upper-end 14B. For embodiment 10A, fluids-augmentable (and normally dry) brush-like fluids applicators helically surround and are attached to said shafts 11A and 11B above lower-ends 12A and 12B as such applicators 13M and 13N. Located loftily above (e.g. at 14A, 14B) and joining said vertical shafts 11B and 11B is a directionally transversely extending and horizontal bridge member 15. Manually wieldable handle means (16) are attached to and extend rigidly loftily above bridge member 15. A such handle means (16) might comprise a vertical stem (17) centrally rigidly extending along vertical-axis 10V to bridge 15 and stemwise loftily having a knob 18. The such components 11A, 11B, 15, and 17, might be together unitarily molded of the same continuous resinous material.

As to the representative alternative embodiment 10B for the “Upwardly-Joined Fluids Applicator” concept depicted in Drawing FIGS. 2-4, such embodiment 10B differs from said embodiment 10A only that for embodiment 10B the helical fluids-augmentable helical brush-like elements 13M and 13N are replaced with fluids-augmentable downwardly extending brush-like brush-like elements 13F and 13G that are respectively adhesively attached (13K) to and extend downwardly from the shafts' respective lower-ends 12A and 12B.

Appended Drawing FIGS. 5-7 indicate that the “Upwardly-Joined Fluids Applicator” general concept (10) of the present invention is desireably removably downwardly insertable into a receptacle (e.g. 20A, 20B) chargeable therewithin with appropriate surfaces-affinative fluids (e.g. 28, 29A, 29B, etc.).

The representative embodiment receptacle 20A of Drawing FIGS. 5 and 6 has sidewalls annularly surrounding a vertical central-axis 20V and which might become colinear with the vertical-axis 10V of representative “Fluids Applicators” 10A and 10B. Such representative-receptacle embodiment 20A has its upright sidewalls conventionally attached to a horizontal e.g. rectangular, roof-element loftily overlying a similar base-element 22. For roof-element 23 are roof-apertures 24A and 24B which are desireably provided with annular resinous gaskets 25A and 25B adapted to yieldably resiliently-compressively surround the respective shaft portions 11A and 11B of a selectable “Fluids Applicator” (e.g. 10A, 10B). Internally chargeable within a said receptacle embodiment 20A is a surfaces affinative fluid (28) which might take the form, inter alia, of cosmetic material such as for eyelashes, cheeks, labial areas, etc. However, if the shafts' lower portions are provided with fluids applicator elements taking the forms of semi-solid cosmetics, the accompanyable receptacle (e.g. 20A, 20B) might be devoid of additional surface-affinity fluid (e.g. 28, 29A, 29B), except possibly for a refreshing moisturize for any such semi-solids cosmetic.

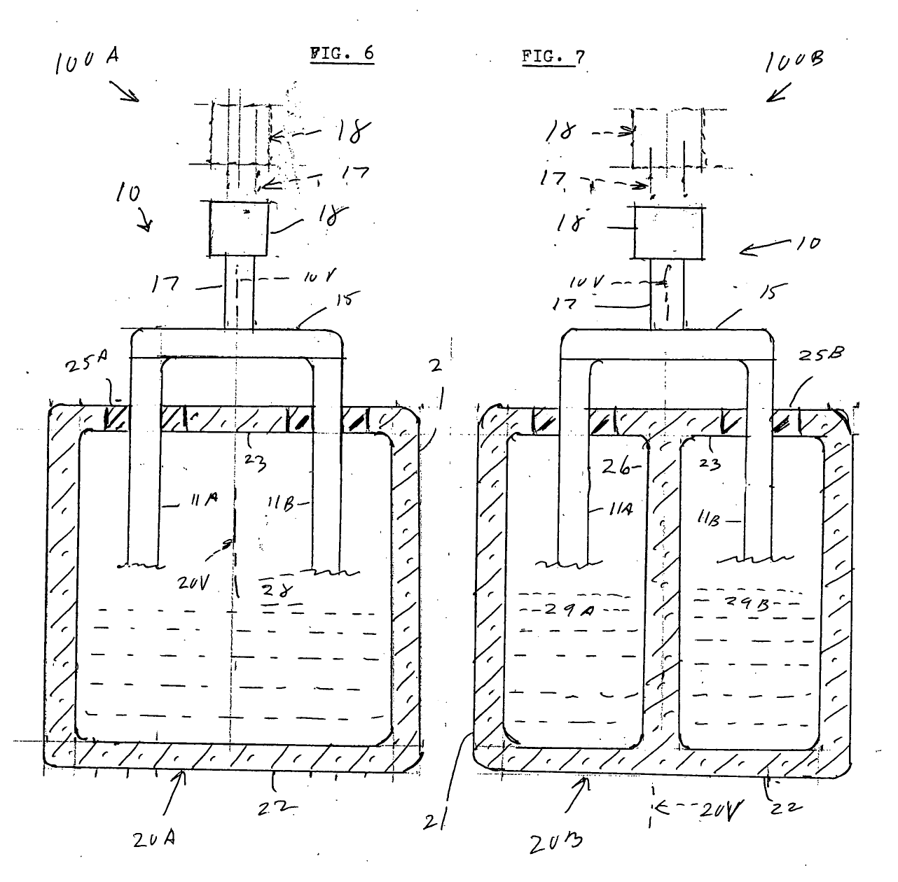

The alternative receptacle embodiment 20B depicted in Drawing FIGS. 5 and 7 might additionally include therewithin an upright partition-wall 26 extending along central-axis 20V to provide receptacle upright internal chambers 26A and 26B chargeable therewithin with visually and/or chemically different surface-affinity fluids (29A, 29B) for f respective fluids applications therefrom e.g. from fluids applicators 13M and 13N.

From the foregoing, the construction and operational usage of the “Upwardly-Joined Fluids Applicators (and Receptacles therefor)” of the present invention will be readily understood and further explanation is believed to be unnecessary. However, since numerous modifications and changes will readily occur to those skilled in the art, it is not desired to limit the invention to the exact constructions shown and described, and accordingly, all suitable modifications and equivalents may be resorted to, following within the scope of the appended claims.

1. Upwardly-Joined Fluids Applicator concept comprising:
(A) a plurality of substantially parallel and directionally longitudinal and directionally transversely separated vertical shafts respectively extending along parallel vertical-axes, and each of which vertical shafts has a lower-end and a brush-like element attached to and proximately to a shaft lower-end;
(B) located loftily of the lower-end and the proximate brush-like elements of the said parallel plural vertical shafts, a directionally transversely extending and substantially horizontal bridge member connected to upper portions of the respective vertical shafts; and
(C) extending upwardly from the said bridge member, a manually wieldable handle means.

2. The Upwardly-Joined Fluids Applicator concept of claim 1 wherein the respective brush-like elements attachably surround the vertical-axis and extending upwardly from the lower-end of each said vertical shaft.

3. The Upwardly-Joined Fluids Applicator concept of claim 1 wherein the respective brush-like applicator elements are attached to a vertical shaft lower-end and extend downwardly therefrom.

4. The Upwardly-Joined Fluids Applicator concept of claim 1 in a removably downwardly insertable combination with a receptacle that surrounds a vertically extending central-axis and includes a directionally transverse and substantially horizontal roof-element, said roof-element in flanking relationship to said receptacle central-axis being provided with roof-apertures respectively surrounding vertical shafts of a said Upwardly-Joined Fluids Applicator.

5. The Fluids Applicator and Receptacle combination of claim 4 wherein there are resiliently compressive means extending between the respective Fluids Applicator vertical shafts and the Receptacle's roof-apertures.

6. The combination of claim 5 wherein the resiliently compressive mens comprises an elastic annular gasket attached to the receptacle surrounding respective roof-apertures thereof.

7. The combination of claim 4 wherein the respective brush-like elements attachably surround and extending upwardly from the lower-end of each said vertical shaft; and wherein the said receptacle is charged therewithin of a selectable treatments fluids for beautifying human eyelashes.

8. The combination of claim 4 wherein the respective brush-like elements are attached to a vertical shaft lower-end and extend downwardly therefrom; wherein the receptacle is uprightly internally divided into a plurality of upwardly extending receptacle-compartments, one assigned to each said Fluids Applicator shafts and also assigned to the brush-like element therefor;
and wherein each said distinct receptacle compartment is charged with a visually distinct and compartments differing fluid.

9. Upwardly-Joined Fluids Applicator concept comprising:
(A) a plurality of substantially parallel and directionally longitudinal and directionally transversely separated vertical shafts respectively extending along parallel vertical-axes, and each of which vertical shafts has a lower-end and thereat carrying an applicator element for applying a selectable fluid to a receptive surface therefor;
(B) located loftily of the said vertical shafts' lower-ends, a directionally transversely extending and substantially horizontal bridge member connected to upper portions of the respective vertical shafts; and
(C) attached to and extending upwardly from said bridge member, a manually wieldable handle means.
